(19) United States
(12) Patent Application Publication
(10) Pub. No.: US 2016/0093269 A1
(43) Pub. Date: Mar. 31, 2016

(54) Laser-Pumped Phosphor Backlight and Methods

(71) Applicant: Pixtronix, Inc., San Diego, CA (US)

(72) Inventors: Edward Buckley, Melrose, MA (US); Fahri Yaras, Reading, MA (US)

(21) Appl. No.: 14/498,718

(22) Filed: Sep. 26, 2014

(51) Int. Cl. G09G 5/10; F21V 8/00; G06T 1/20; F21K 99/00

(52) U.S. Cl. CPC G09G 5/10; F21K 9/56; G02B 6/0026; G02B 6/005; G02B 6/0031; G02B 6/0018; G06T 1/20; F21Y 2101/025

(57) ABSTRACT

This disclosure provides systems, methods and apparatus for a laser-pumped phosphor backlight for display devices. In one aspect, a display includes a laser backlight configured to emit light, a plurality of phosphors that emit light at a respective wavelength when stimulated by light emitted by the laser backlight, and a waveguide including a diffraction grating positioned between the laser backlight and the plurality of phosphors. In some implementations, the diffraction grating may be configured to direct the light emitted by the laser backlight at a different intensity for each of the plurality of phosphors. For example, the diffraction grating may direct the light at different intensities for each of the plurality of phosphors by generating a diffraction pattern such that the light emitted by the laser backlight is distributed at different relative intensities for each of the plurality of phosphors.

### TECHNICAL FIELD

This disclosure relates to the field of display devices, and more particularly, to a laser-pumped phosphor backlight for display use in display devices.

### DESCRIPTION OF THE RELATED TECHNOLOGY

Conventional display devices, such as LCD displays, typically include a white LED-based backlight combined with an LCD stack. The conventional backlight combined with the LCD stack can be inefficient because the white LED-based backlight requires a color filter and an additional polarizer to condition the light for display in an RGB pixel structure. The color filter and polarizer can cause significant loss of light from the backlight resulting in an inefficient use of power for the LCD device. Thus, there exists a need for improved backlights for display devices which avoid the inefficiencies of the color filter and polarizer.

### SUMMARY

The systems, methods and devices of this disclosure each have several innovative aspects, no single one of which is solely responsible for the desirable attributes disclosed herein.

One innovative aspect of the subject matter described in this disclosure can be implemented in a display apparatus including a laser backlight configured to emit light, a plurality of phosphors that emit light at a respective wavelength when stimulated by light emitted by the laser backlight, and a waveguide including a diffraction grating positioned between the laser backlight and the plurality of phosphors. The diffraction grating can be configured to direct the light emitted by the laser backlight towards the plurality of phosphors. In some implementations, the diffraction grating can be configured to direct the light emitted by the laser backlight at a different intensity for each of the plurality of phosphors. The diffraction grating may direct the light at different intensities for each of the plurality of phosphors by generating a diffraction pattern such that the light emitted by the laser backlight is distributed at different relative intensities for each of the plurality of phosphors. In some implementations, the diffraction grating may direct the light at a relative intensity of 17% towards a first of the three phosphors, 71% towards a second of the three phosphors, and 12% towards a third of the three phosphors.

In some implementations, the plurality of phosphors make up a pixel of the display. For example, the plurality of phosphors may include a red phosphor, a green phosphor, and a blue phosphor. In some implementations, the three phosphors can be configured to collectively emit substantially white light when stimulated. In some implementations, the laser backlight can be configured to emit light at a first wavelength of 405 nm or 445 nm.

In some implementations, the display may further include a diffuser such that the plurality of phosphors are positioned between the diffuser and the waveguide. In some implementations, the waveguide may include a reflective layer such that the diffraction grating is positioned between the plurality of phosphors and the reflective layer. The display also may include a lens positioned between the phosphors and the diffraction grating configured to focus light directed by the diffraction grating towards the plurality of phosphors.

In some implementations, the display may further include a plurality of light modulators, a processor capable of communicating with the plurality of light modulators and processing image data, and a memory device capable of communicating with the processor. The display also may include a driver circuit capable of sending at least one signal to the plurality of light modulator and a controller capable of sending at least a portion of the image data to the driver circuit. In some implementations, the display may further include an image source module capable of sending the image data to the processor. The image source module may include at least one of a receiver, transceiver, and transmitter. In some implementations, the display may further include an input device capable of receiving input data and communicating the input data to the processor.

Another innovative aspect of the subject matter described in this disclosure can be implemented in a display including a laser backlight configured to emit light and an array of pixels. Each pixel may include a plurality of phosphors, and each phosphor may emit light at a respective wavelength when stimulated by light emitted by the laser backlight. The display may further include a waveguide including a diffraction grating positioned between the laser backlight and the plurality of phosphors, and the diffraction grating may be configured to direct the light emitted by the laser backlight towards the array of pixels. The display may further include a plurality of light modulators, and each light modulator may be configured to obstruct light in a first state and pass light in a second state.

In some implementations, the diffraction grating may be configured to direct the light emitted by the laser backlight at a different intensity for each of the plurality of phosphors in each pixel. The diffraction grating may be configured to direct the light emitted by the laser backlight at the different intensity for each of the plurality of phosphors by generating a diffraction pattern such that the light emitted by the laser backlight is distributed at different relative intensities for each of the plurality of phosphors. In some implementations, each pixel may include three phosphors, and the diffraction grating may be configured to direct the light emitted by the laser backlight at a relative intensity of 17% towards a first of the three phosphors, 71% towards a second of the three phosphors, and 12% towards a third of the three phosphors. In some implementations, each pixel may include a red phosphor, a green phosphor, and a blue phosphor, and the three phosphors may collectively emit substantially white light when stimulated. In some implementations, the laser backlight may be configured to emit light at a first wavelength of one of: 405 nm or 445 nm.

In some implementations, the display may further include a diffuser such that the array of pixels are positioned between the diffuser and the waveguide. The waveguide may include a reflective layer such that the diffraction grating is positioned between the array of pixels and the reflective layer. The display may further include a lens positioned between the array of pixels and the diffraction grating, and the lens may be configured to focus light directed by the diffraction grating towards the array of pixels. In some implementations, the plurality of light modulators may be positioned such that the array of pixels is positioned between the plurality of light modulators and the waveguide.

In some implementations, the display may further include a processor capable of communicating with the plurality of light modulators and processing image data and a memory device capable of communicating with the processor. The display may further include a driver circuit capable of sending at least one signal to the plurality of light modulators and a controller capable of sending at least a portion of the image data to the driver circuit. In some implementations, the display may further include an image source module capable of sending the image data to the processor. The image source module includes at least one of a receiver, transceiver, and transmitter. In some implementations, the display may further include an input device capable of receiving input data and communicating the input data to the processor.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3 shows an example display apparatus with a laser-pumped phosphor backlight.

FIG. 4 shows a cross-sectional view of an example display apparatus with a laser-pumped phosphor backlight.

FIG. 5 shows a cross-sectional view of another example display apparatus with a laser-pumped phosphor backlight.

FIGS. 6A and 6B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Displays, including a laser-pumped phosphor backlight, are among the systems and methods described herein. The display may include a plurality of pixels, with each pixel including a plurality of phosphors that emit light at a respective wavelength when stimulated by light emitted by a laser backlight. The laser backlight may emit light at any suitable wavelength or combination of wavelengths, including, but not limited to, light in the visible spectrum, infrared spectrum, or ultraviolet spectrum. In some implementations, the laser backlight may emit light at a wavelength of 405 nm or 445 nm. The display may include a waveguide including a diffraction grating positioned between the laser backlight and the plurality of phosphors configured to direct the light emitted by the laser backlight towards the plurality of phosphors. The diffraction grating may generate a diffraction pattern such that the light emitted by the laser backlight is distributed at different relative intensities for each of the plurality of phosphors. In some implementations, the diffraction grating may direct the light at a relative intensity between 10% and 30% towards a first of the three phosphors, between 40% and 80% towards a second of the three phosphors, and between 10% and 30% towards a third of the three phosphors. As an illustrative example, the diffraction grating may direct light at a relative intensity of 17%, 71%, and 12% towards the first, second, and third phosphors, respectively. The three phosphors may be a red phosphor, a green phosphor, and a blue phosphor, and in some implementations, the three phosphors can be configured to collectively emit substantially white light when stimulated.

Particular implementations of the subject matter described in this disclosure can be implemented to realize one or more of the following potential advantages. In some implementations, the systems and methods described herein may improve the efficiencies of display devices. For example, conventional LCD displays typically include a white LED-based backlight combined with an LCD stack. The conventional white backlight requires a color filter and a polarizer to condition the light for display in an RGB pixel structure. The color filter and the polarizer cause a loss of light from the backlight resulting in an inefficient use of power for the LCD displays. The laser-pumped phosphor backlight as described herein utilizes a laser backlight to directly illuminate color phosphors to generate an RGB pixel structure, and thus achieves illumination of color sub-pixels by emission, rather than filtering. Therefore, display devices which utilize a laser-pumped phosphor backlight do not require a color filter and may avoid the inefficiencies associated with such components. It may also be possible to remove one of the polarizing surfaces if the laser illumination has a high extinction ratio. Furthermore, UV-based laser diodes exhibit high efficiency and excellent power linearity compared to conventional white LED-based backlights, thus further improving the efficiency of display devices utilizing a laser-pumped phosphor backlight. Finally, displays which utilize UV-based laser diodes may exhibit a wider color gamut and may be able to be manufactured at lower cost than existing displays.

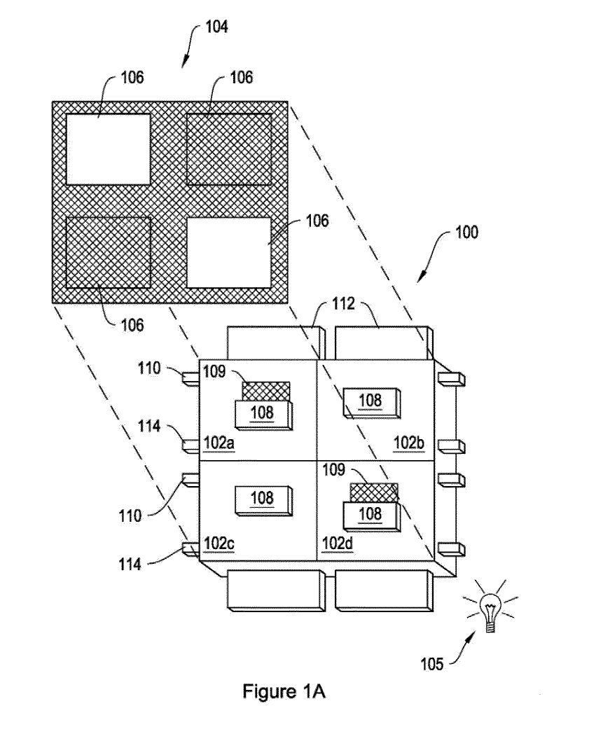

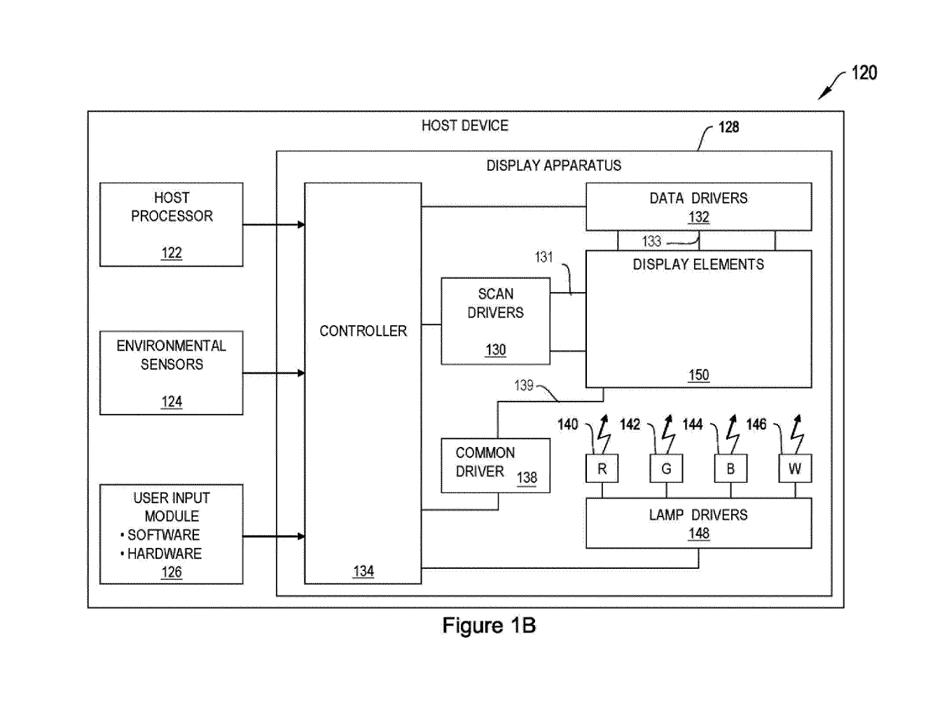

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

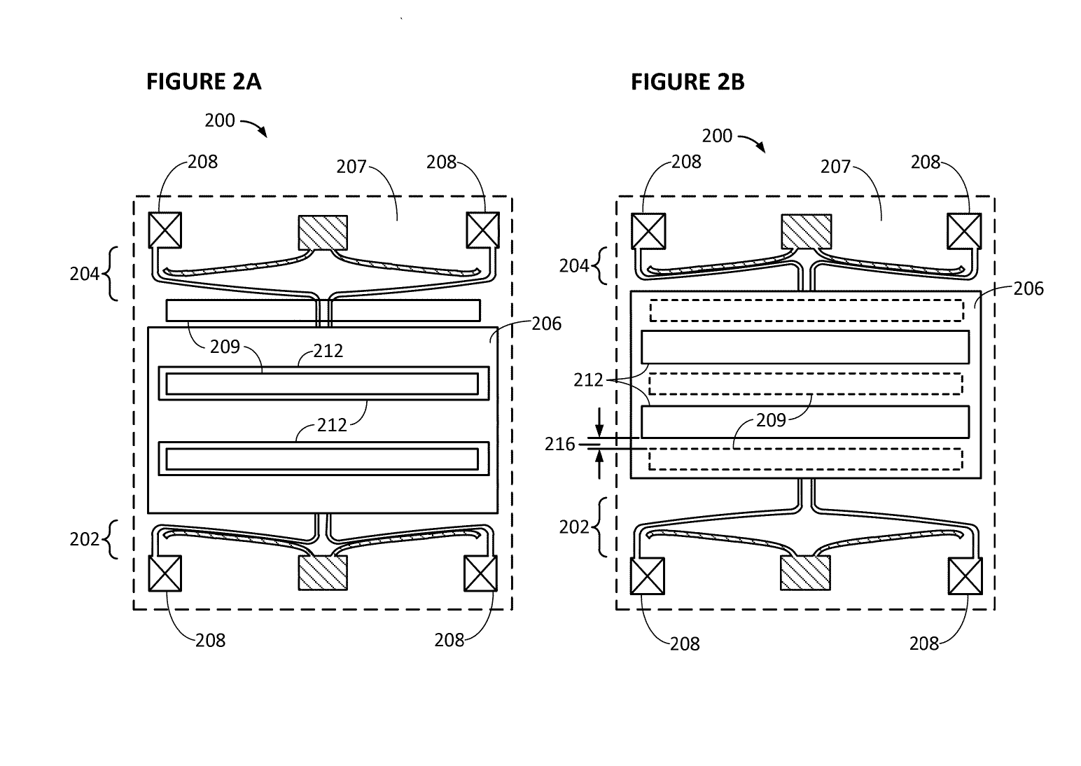

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

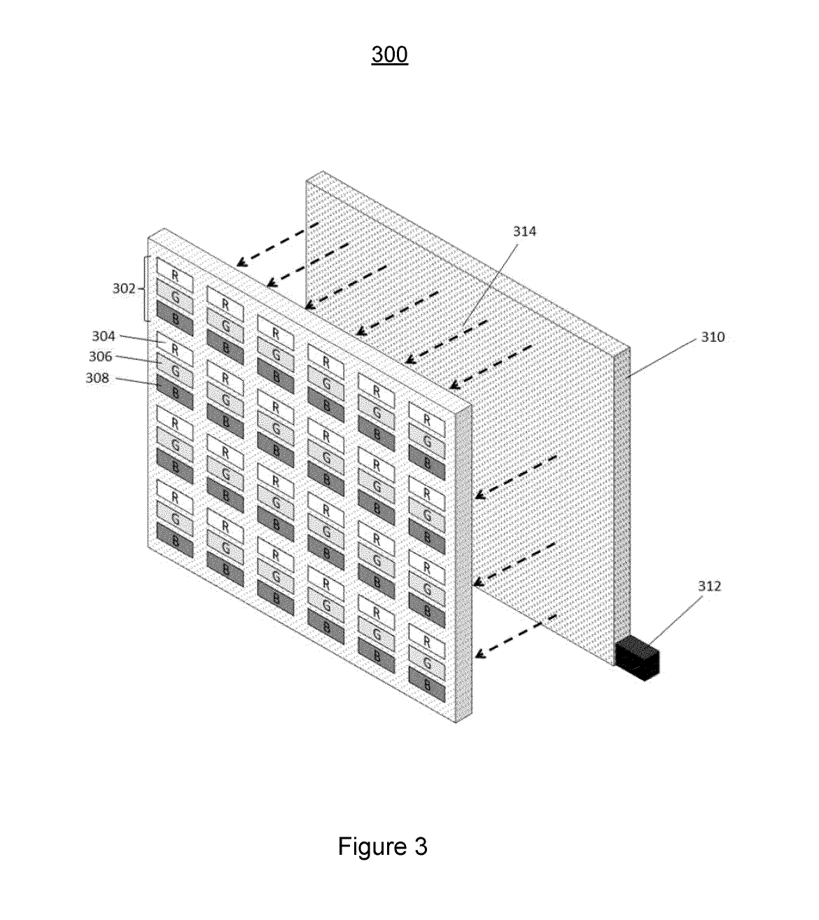

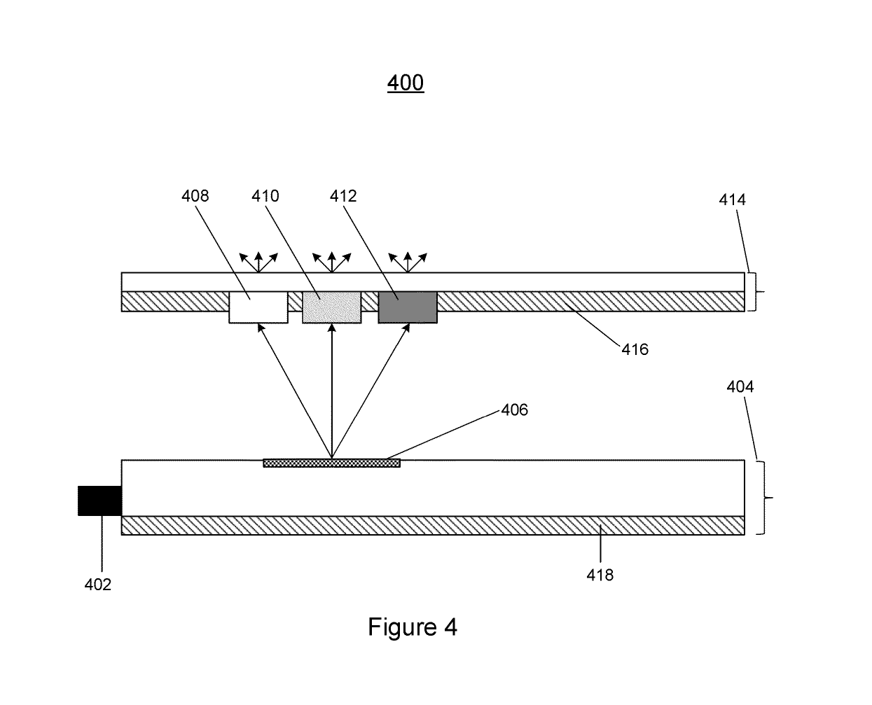

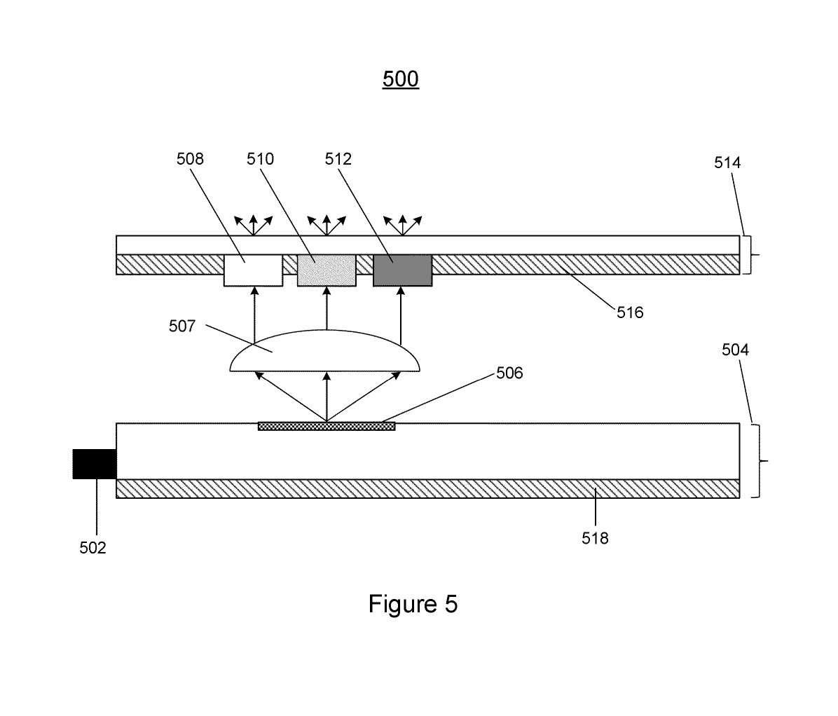

FIG. 3 shows an example display apparatus 300 with laser-pumped phosphor backlight. The display apparatus 300 may include a plurality of pixels 302, each pixel including a plurality of sub-pixels 304, 306, and 308. The display apparatus 300 may also include a laser backlight 312 and waveguide 310, which directs light 314 from the laser backlight 312 towards the plurality of pixels 302. In certain implementations, subpixel 304 may be configured to emit red light, sub-pixel 306 may be configured to emit green light, and subpixel 308 may be configured to emit blue light. In conventional LCD displays, each of the sub-pixels 304, 306, and 308 may be illuminated by a substantially white LED-based backlight through a color filter may. In displays utilizing a laser-pumped phosphor backlight, as described in further detail below in relation to FIGS. 4 and 5, each of the subpixels 304, 306, and 308 may correspond to a phosphor configured to emit light at a different frequency when illuminated by light from laser backlight 312. The subpixels 304, 306, and 308 may be made from any suitable illuminative material, including, but not limited to CE³′-doped garnets (such as Y₃Al₅O₁₂:Ce³⁺)), Eu²⁺-doped nitride and oxynitride phosphors, and Eu2+-doped M₂SiO₄ (where M=Ca²⁺, Sr²⁺, and/or Ba²⁺). The phosphors may be illuminated by a UV-laser diode, such as laser backlight 312, emitting light at either 405 nm or 445 nm, and the phosphors may be configured to emit red, green, and blue light for the respective subpixels 304, 306, and 308. The waveguide 310 may be configured to direct light 314 from the laser backlight 312 towards each of the pixels 302. In some implementations, as discussed further below in relation to FIGS. 4 and 5, the waveguide 310 may include a diffraction grating configured to direct light 314 at different relative intensities for each of the subpixels 304, 306, 308, in order to achieve the correct balance of red, green, and blue to achieve the desired color point when all three subpixels are illuminated. For example, the diffraction grating may be configured to direct light 314 at the subpixels 304, 306, and 308 in order to achieve a D65 white point when all three subpixels are illuminated by light 314 from laser backlight 312.

In some implementations, each of the pixels 302 may have a corresponding light modulator, such as light modulator 102 depicted in FIG. 1A. In other implementations, each of the subpixels 304, 306, and 308 may have separate color-specific light modulators. The light modulator may have a substantially open state and a substantially closed state, and an image may be formed by selectively opening and closing the array of light modulators for pixels 302. For example, by selectively opening a set of three light modulators per pixel, corresponding to subpixels 304, 306, and 308, the display 300 may control the amount of red, green, and blue light to generate a color pixel 302. The plurality of pixels 302 may be combined to form a color image.

FIG. 4 shows a cross-sectional view of an example display apparatus with a laser-pumped phosphor backlight. The display 400 includes a laser backlight 402, a waveguide 404, a diffraction grating 406, phosphors 408, 410, and 412, a diffuser 414, and reflective surfaces 416 and 418. The laser backlight 402 may be any suitable light source for providing light at a certain wavelength. For example, the laser backlight may be a UV-laser diode, such as a multimode pump diode, configured to output light at a wavelength of either 405 nm or 445 nm. The laser backlight 402 may be coupled to the waveguide 404, which directs lights towards the phosphors 408, 410, and 412. In some implementations, the phosphors 408, 410, and 412 may include sub-pixels of a single pixel of a display, such as pixel 106 depicted in FIG. 1A or pixel 302 depicted in FIG. 3. In some implementations, the phosphors 408, 410, and 412 may be arranged in such a way as to replicate the layout of conventional color filters in LCD displays. Although FIG. 4 depicts three phosphors 408, 410, and 412, it will be understood by one having ordinary skill in the art that the display 400 may include any number of phosphors arranged in any suitable manner to generate an image.

The waveguide 404 may be made of any suitable material for passing light emitted from the laser backlight 402, including, but not limited to, plastic, glass, or any suitable combination of materials. For instance, in some implementations, the waveguide 404 may be constructed of the plastic polymethylmethacrylate (PMMA). The waveguide 404 may be optically transmissive to the frequency of the light emitted by the laser backlight 402. In some implementations, the waveguide 404 may be optically transmissive to a narrow band of frequencies or multiple frequency bands of light. In some implementations, the waveguide 404 may include reflective surface in order to reduce light leakage and improve light recycling. In other implementations the waveguide may contain the light by total internal reflection.

In certain implementations, one surface of the waveguide 404 may include a diffraction grating 406. The diffraction grating 406 may be constructed on the surface of the waveguide 404 in any suitable manner, including etching, printing, or stamping. The diffraction grating 406 may be configured to direct the light emitted by the laser backlight 402 in different directions and/or at different intensities. For example, the diffraction grating 406 may generate a diffraction pattern that splits the light into three beams directed towards the three phosphors 408, 410, and 412. In some implementations, the relative intensities of the three beams may be 17%, 71%, and 12% respectively for the three phosphors 408, 410, and 412. These intensities may cause the phosphors 408, 410, and 412 to emit the correct balance of red, green, and blue to produce a standard D65 white point. It will be understood by those skilled in the art that the diffraction grating may be configured to direct light at any combination of relative intensities for the three phosphors 408, 410, and 412 such that the three phosphors collectively produce a standard D65 white point, or any other desired color output.

In the example display 400 depicted in FIG. 4, the diffraction grating 406 is configured to operate in the near-field. According to the Fresnel diffraction equation for near-field diffraction, the propagation distance d is governed by the following equation:

$$\frac{{w}^{2}}{λ d} ≫ 1$$

In the above equation, λ is the wavelength of the light emitted by the laser backlight, w is the width of the diffraction grating, and d is the propagation distance needed to guarantee near-field diffraction. As an illustrative example, a typical 326 ppi display in a mobile telephone has an RGB pixel size of about 78 μm square. In order to adequately cover the RGB phosphors, the diffraction grating must have a width on the order of w=80 μm. Assuming a diffraction grating aperture width w=80 μm, a wavelength λ=405 nm, and assuming that

$$\frac{{w}^{2}}{λ d}$$

is 10, a propagation distance of d=1.5 mm is needed.

In some implementations, the display 400 may include a diffuser 414. The diffuser 414 may be made from any substantially transparent to allow light emitted from the phosphors 408, 410, and 412 to pass through. In some implementations, the diffuser 414 may improve angular diversity of the emission profile, allowing the display to be viewed from a wider range of viewing angles. In some implementations, the diffuser 414 may include a reflective surface 416 on one side to improve light recycling. A corresponding reflective surface 418 may be included on waveguide 404 to aid in the light recycling. In some implementations, the phosphors 408, 410, and 412 may be deposited, printed, etched, or applied as a coating directly onto diffuser 414 and/or the reflective surface 416.

FIG. 5 shows a cross-sectional view of another example display apparatus with a laser-pumped phosphor backlight. The display 500 includes a laser backlight 502, a waveguide 504, a diffraction grating 506, phosphors 508, 510, and 512, a diffuser 514, reflective surfaces 516 and 518, and microlens 507. The laser backlight 502, waveguide 504, a diffraction grating 506, phosphors 508, 510, and 512, a diffuser 514, and reflective surfaces 516 and 518 may be substantially similar to the corresponding components discussed above in relation to FIG. 4. For instance, the laser backlight 502 may be coupled to the waveguide 504, which directs light to the phosphors 508, 510, and 512 using diffraction grating 506. The diffraction grating 506 may be configured to split the light emitted by the laser backlight 502 in different directions and/or at different intensities towards the three phosphors 508, 510, and 512. In some implementations, the relative intensities of the three beams may be 17%, 71%, and 12% respectively for the three phosphors 508, 510, and 512. In some implementations, these intensities may be configured so that the phosphors 408, 410, and 412 emit the correct balance of red, green, and blue to produce a standard D65 white point. As will be appreciated by one having ordinary skill in the art, the direction and/or intensity of the light may be adjusted to produce any suitable balance of red, green, and blue when all three phosphors 508, 510, and 512 are stimulated.

In the example display 500 depicted in FIG. 5, the diffraction grating 506 is configured to operate in the far-field. As will be appreciated by one having ordinary skill in the art, the Fraunhofer diffraction equation is used to model the diffraction of waves when the diffraction pattern is viewed at a relatively long distance from the diffraction object, and also when it is viewed at the focal plane of an imaging lens, such as microlens 507. Specifically, Fraunhofer diffraction occurs when:

$$\frac{{w}^{2}}{λ d} ≪ 1$$

In the above equation, λ is the wavelength of the light emitted by the laser backlight, w is the width of the diffraction grating aperture (slit size), and d is the distance from the diffraction grating. As an illustrative example, assuming a diffraction grating width w=80 μm (corresponding to a typical 326 ppi display), a wavelength λ=405 nm, a propagation distance of d=16 mm is needed for Fraunhofer diffraction.

In some implementations, this propagation distance may be reduced by use of an imaging lens, such as microlens 507. If the microlens focal length is f, the backlight wavelength is λ, and the diffraction grating feature size (aperture) is A, then the diffracted field size S may be calculated using the equation:

$$S = \frac{f λ}{Δ}$$

As an illustrative example, assuming a pixel size of 80 μm, the diffracted field size S must also be 80 μm in order to adequately cover the three phosphors 508, 510, and 512. If 200 grating periods are needed to achieve a high diffraction efficiency, then the microlens focal length should be f=80 μm, requiring an f-number of f_{#}=f/w=1.

### Efficiency Calculation

An optical throughput calculation for a typical LCD display is provided in Table 1 below, and shows that the total throughput efficiency is on the order of 3%. As discussed above, the major loss mechanisms are due to the color filters and polarizer/analyzer combination. This leads to a very low display efficacy figure, where display efficacy is defined as the ratio of luminous flux output to electrical power input.

TABLE 1
Typical LCD panel and backlight transmission factors

| Lightguide efficiency | 60% | |
|---|---|---|
| Diffuser | 95% | |
| Polarizer | 45% | |
| LCD aperture ratio | 60% | |
| Color filter | 17% | |
| Analyzer | 85% | |
| DBEF | 140% | |
| Total Throughput | 3% | |
| LED electrical-to-optical | 150 | lm/W |
| conversion efficiency | | |
| Display efficacy | 4.5 | lm/W |

If a white LED with electrical-to-optical conversion efficiency of 150 lm/W is used to illuminate this backlight, then 1 W of electrical power gives rise to 4.7 lm at the display. A similar analysis for an example laser backlight is provided below in Table 2. A potential recycling gain factor has been omitted in Table 2.

TABLE 2
Phosphor backlight transmission factors

| Lightguide efficiency | 85% | |
|---|---|---|
| Diffuser | 95% | |
| Microlens and diffraction grating | 85% | |
| Polarizer | 45% | |
| LCD aperture ratio | 60% | |
| Scattering from phosphors | 80% | |
| Total Throughput | 14.8% | |
| Red phosphor conversion efficiency | 63% | |
| Green phosphor conversion efficiency | 76% | |
| Blue phosphor conversion efficiency | 91% | |
| Total conversion efficiency after | 77% | |
| photopic weighting | | |
| 405 nm laser optical power | 1,000 | mW |
| Current | 1,000 | mA |
| Voltage | 3.2 | V |
| Luminous flux supplied by backlight | 770 | lm |
| Laser electrical-to-optical conversion | 241 | lm/W |
| efficiency | | |
| Display efficacy | 36 | lm/W |

As shown in Tables 1 and 2 above, the phosphor backlight provides a much higher display efficacy, partly due to the omission of a color filter and one polarizing surface, and partly due to the efficiency of a laser-based backlight.

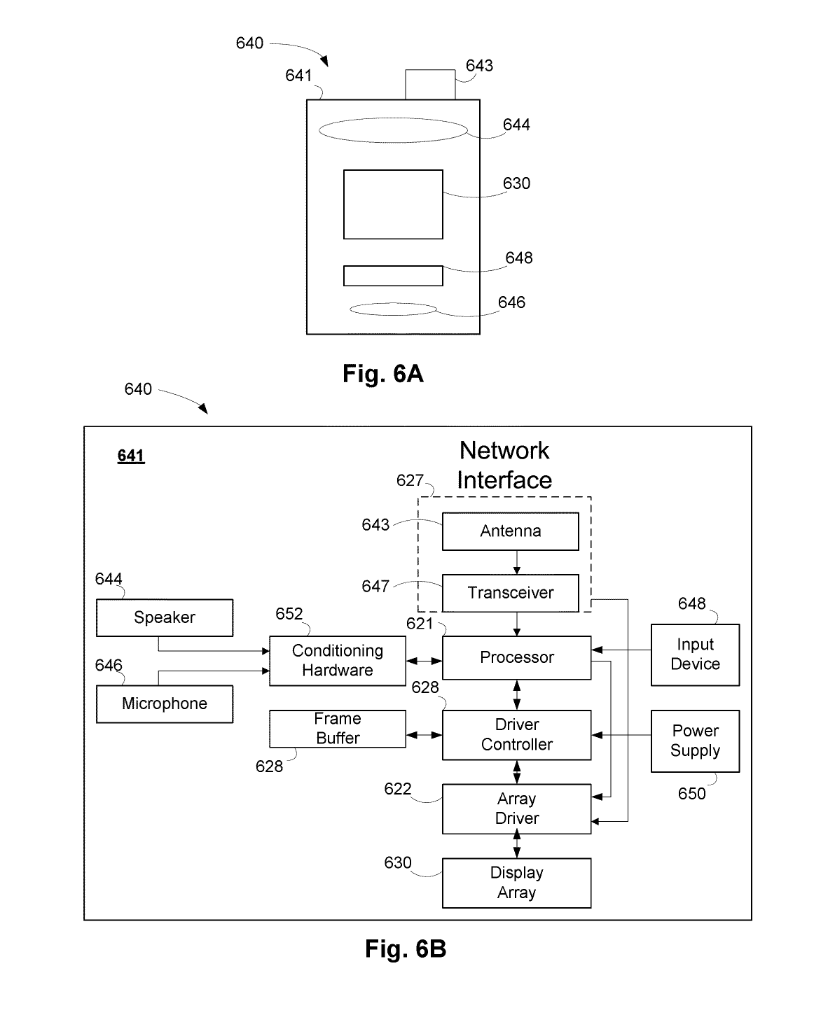

FIGS. 6A and 6B show system block diagrams of an example display device 640 that includes a plurality of display elements. The display device 640 can be, for example, a smart phone, a cellular or mobile telephone. However, the same components of the display device 640 or slight variations thereof are also illustrative of various types of display devices such as televisions, computers, tablets, e-readers, hand-held devices and portable media devices.

The display device 640 includes a housing 641, a display 630, an antenna 643, a speaker 645, an input device 648 and a microphone 646. The housing 641 can be formed from any of a variety of manufacturing processes, including injection molding, and vacuum forming. In addition, the housing 641 may be made from any of a variety of materials, including, but not limited to: plastic, metal, glass, rubber and ceramic, or a combination thereof. The housing 641 can include removable portions (not shown) that may be interchanged with other removable portions of different color, or containing different logos, pictures, or symbols.

The display 630 may be any of a variety of displays, including a phosphor backlight-based display, as described herein. The display 630 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 630 can include a mechanical light modulator-based display, as described herein.

The components of the display device 640 are schematically illustrated in FIG. 6B. The display device 640 includes a housing 641 and can include additional components at least partially enclosed therein. For example, the display device 640 includes a network interface 627 that includes an antenna 643 which can be coupled to a transceiver 647. The network interface 627 may be a source for image data that could be displayed on the display device 640. Accordingly, the network interface 627 is one example of an image source module, but the processor 621 and the input device 648 also may serve as an image source module. The transceiver 647 is connected to a processor 621, which is connected to conditioning hardware 652. The conditioning hardware 652 may be configured to condition a signal (such as filter or otherwise manipulate a signal). The conditioning hardware 652 can be connected to a speaker 645 and a microphone 646. The processor 621 also can be connected to an input device 648 and a driver controller 629. The driver controller 629 can be coupled to a frame buffer 628, and to an array driver 622, which in turn can be coupled to a display array 630. One or more elements in the display device 640, including elements not specifically depicted in FIG. 6A, can be capable of functioning as a memory device and be capable of communicating with the processor 621. In some implementations, a power supply 650 can provide power to substantially all components in the particular display device 640 design.

The network interface 627 includes the antenna 643 and the transceiver 647 so that the display device 640 can communicate with one or more devices over a network. The network interface 627 also may have some processing capabilities to relieve, for example, data processing requirements of the processor 621. The antenna 643 can transmit and receive signals. In some implementations, the antenna 643 transmits and receives RF signals according to any of the IEEE 16.11 standards, or any of the IEEE 802.11 standards. In some other implementations, the antenna 643 transmits and receives RF signals according to the Bluetooth® standard. In the case of a cellular telephone, the antenna 643 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 647 can pre-process the signals received from the antenna 643 so that they may be received by and further manipulated by the processor 621. The transceiver 647 also can process signals received from the processor 621 so that they may be transmitted from the display device 640 via the antenna 643.

In some implementations, the transceiver 647 can be replaced by a receiver. In addition, in some implementations, the network interface 627 can be replaced by an image source, which can store or generate image data to be sent to the processor 621. The processor 621 can control the overall operation of the display device 640. The processor 621 receives data, such as compressed image data from the network interface 627 or an image source, and processes the data into raw image data or into a format that can be readily processed into raw image data. The processor 621 can send the processed data to the driver controller 629 or to the frame buffer 628 for storage. Raw data typically refers to the information that identifies the image characteristics at each location within an image. For example, such image characteristics can include color, saturation and gray-scale level.

The processor 621 can include a microcontroller, CPU, or logic unit to control operation of the display device 640. The conditioning hardware 652 may include amplifiers and filters for transmitting signals to the speaker 645, and for receiving signals from the microphone 646. The conditioning hardware 652 may be discrete components within the display device 640, or may be incorporated within the processor 621 or other components.

The driver controller 629 can take the raw image data generated by the processor 621 either directly from the processor 621 or from the frame buffer 628 and can re-format the raw image data appropriately for high speed transmission to the array driver 622. In some implementations, the driver controller 629 can re-format the raw image data into a data flow having a raster-like format, such that it has a time order suitable for scanning across the display array 630. Then the driver controller 629 sends the formatted information to the array driver 622. Although a driver controller 629 is often associated with the system processor 621 as a stand-alone Integrated Circuit (IC), such controllers may be implemented in many ways. For example, controllers may be embedded in the processor 621 as hardware, embedded in the processor 621 as software, or fully integrated in hardware with the array driver 622.

The array driver 622 can receive the formatted information from the driver controller 629 and can re-format the video data into a parallel set of waveforms that are applied many times per second to the hundreds, and sometimes thousands (or more), of leads coming from the display's x-y matrix of display elements. In some implementations, the array driver 622 and the display array 630 are a part of a display module. In some implementations, the driver controller 629, the array driver 622, and the display array 630 are a part of the display module.

In some implementations, the driver controller 629, the array driver 622, and the display array 630 are appropriate for any of the types of displays described herein. For example, the driver controller 629 can be a conventional display controller or a bi-stable display controller (such as a mechanical light modulator display element controller). Additionally, the array driver 622 can be a conventional driver or a bi-stable display driver (such as a mechanical light modulator display element controller). Moreover, the display array 630 can be a conventional display array or a bi-stable display array (such as a display including an array of mechanical light modulator display elements). In some implementations, the driver controller 629 can be integrated with the array driver 622. Such an implementation can be useful in highly integrated systems, for example, mobile phones, portable-electronic devices, watches or small-area displays.

In some implementations, the input device 648 can be configured to allow, for example, a user to control the operation of the display device 640. The input device 648 can include a keypad, such as a QWERTY keyboard or a telephone keypad, a button, a switch, a rocker, a touch-sensitive screen, a touch-sensitive screen integrated with the display array 630, or a pressure- or heat-sensitive membrane. The microphone 646 can be configured as an input device for the display device 640. In some implementations, voice commands through the microphone 646 can be used for controlling operations of the display device 640. Additionally, in some implementations, voice commands can be used for controlling display parameters and settings.

The power supply 650 can include a variety of energy storage devices. For example, the power supply 650 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 650 also can be a renewable energy source, a capacitor, or a solar cell, including a plastic solar cell or solar-cell paint. The power supply 650 also can be configured to receive power from a wall outlet.

In some implementations, control programmability resides in the driver controller 629 which can be located in several places in the electronic display system. In some other implementations, control programmability resides in the array driver 622. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display comprising:
a laser backlight configured to emit light;
a plurality of phosphors, wherein each phosphor emits light at a respective wavelength when stimulated by light emitted by the laser backlight; and
a waveguide including a diffraction grating positioned between the laser backlight and the plurality of phosphors, wherein the diffraction grating is configured to direct the light emitted by the laser backlight towards the plurality of phosphors.

2. The display of claim 1, wherein the diffraction grating is configured to direct the light emitted by the laser backlight at a different intensity for each of the plurality of phosphors.

3. The display of claim 2, wherein the diffraction grating is configured to direct the light emitted by the laser backlight at the different intensity for each of the plurality of phosphors by generating a diffraction pattern such that the light emitted by the laser backlight is distributed at different relative intensities for each of the plurality of phosphors

4. The display of claim 2, wherein the plurality of phosphors comprises three phosphors, and wherein the diffraction grating is configured to direct the light emitted by the laser backlight at a relative intensity of 17% towards a first of the three phosphors, 71% towards a second of the three phosphors, and 12% towards a third of the three phosphors.

5. The display of claim 1, wherein the plurality of phosphors comprise a pixel of the display.

6. The display of claim 1, wherein the plurality of phosphors comprises a red phosphor, a green phosphor, and a blue phosphor.

7. The display of claim 5, wherein the three phosphors are configured to collectively emit substantially white light when stimulated.

8. The display of claim 1, wherein the laser backlight is configured to emit light at a first wavelength of one of: 405 nm or 445 nm.

9. The display of claim 1, further comprising a diffuser such that the plurality of phosphors are positioned between the diffuser and the waveguide.

10. The display of claim 1, wherein the waveguide comprises a reflective layer such that the diffraction grating is positioned between the plurality of phosphors and the reflective layer.

11. The display of claim 1, further comprising a lens positioned between the phosphors and the diffraction grating, wherein the lens is configured to focus light directed by the diffraction grating towards the plurality of phosphors.

12. The display of claim 1, further comprising:
a plurality of light modulators;
a processor capable of communicating with the plurality of light modulators, the processor being capable of processing image data; and
a memory device capable of communicating with the processor.

13. The display of claim 11, further comprising:
a driver circuit capable of sending at least one signal to the plurality of light modulators; and
a controller capable of sending at least a portion of the image data to the driver circuit.

14. The display of claim 11, further comprising:
an image source module capable of sending the image data to the processor, wherein the image source module includes at least one of a receiver, transceiver, and transmitter.

15. The display of claim 11, further comprising:
an input device capable of receiving input data and communicating the input data to the processor.

16. A display comprising:
a laser backlight configured to emit light;
an array of pixels, each pixel comprising a plurality of phosphors, wherein each phosphor emits light at a respective wavelength when stimulated by light emitted by the laser backlight;
a waveguide including a diffraction grating positioned between the laser backlight and the plurality of phosphors, wherein the diffraction grating is configured to direct the light emitted by the laser backlight towards the array of pixels; and
a plurality of light modulators, wherein each light modulators is configured to obstruct light in a first state and pass light in a second state.

17. The display of claim 16, wherein, for each pixel, the diffraction grating is configured to direct the light emitted by the laser backlight at a different intensity for each of the plurality of phosphors.

18. The display of claim 17, wherein the diffraction grating is configured to direct the light emitted by the laser backlight at the different intensity for each of the plurality of phosphors by generating a diffraction pattern such that the light emitted by the laser backlight is distributed at different relative intensities for each of the plurality of phosphors.

19. The display of claim 17, wherein each pixel comprises three phosphors, and wherein the diffraction grating is configured to direct the light emitted by the laser backlight at a relative intensity of 17% towards a first of the three phosphors, 71% towards a second of the three phosphors, and 12% towards a third of the three phosphors.

20. The display of claim 16, wherein each pixel comprises a red phosphor, a green phosphor, and a blue phosphor.

21. The display of claim 20, wherein the three phosphors comprising each pixel are configured to collectively emit substantially white light when stimulated.

22. The display of claim 16, wherein the laser backlight is configured to emit light at a first wavelength of one of: 405 nm or 445 nm.

23. The display of claim 16 further comprising a diffuser such that the array of pixels are positioned between the diffuser and the waveguide.

24. The display of claim 16, wherein the waveguide comprises a reflective layer such that the diffraction grating is positioned between the array of pixels and the reflective layer.

25. The display of claim 16 further comprising a lens positioned between the array of pixels and the diffraction grating, wherein the lens is configured to focus light directed by the diffraction grating towards the array of pixels.

26. The display of claim 16, wherein the plurality of light modulators are positioned such that the array of pixels is positioned between the plurality of light modulators and the waveguide.
